(19) United States
(12) Patent Application Publication
(10) Pub. No.: US 2026/0179857 A1
(43) Pub. Date: Jun. 25, 2026

(54) ELECTROLYTIC CAPACITOR

(71) Applicant: Panasonic Intellectual Property Management Co., Ltd., Osaka (JP)

(72) Inventors: Momo KUSAKABE, KYOTO FU (JP); Saori UEDA, OSAKA FU (JP)

(21) Appl. No.: 19/545,508

(22) Filed: Feb. 20, 2026

Related U.S. Application Data
(63) Continuation of application No. PCT/JP2024/030584, filed on Aug. 28, 2024.

(30) Foreign Application Priority Data
Aug. 28, 2023 (JP) 2023-138399

(51) Int. Cl. H01G 9/10; H01G 9/048

(52) U.S. Cl. CPC H01G 9/10; H01G 9/048

(57) ABSTRACT

An electrolytic capacitor including a capacitor element having an anode part and a cathode part, a cathode foil electrically connected to the cathode part, and a package body sealing the capacitor element. The capacitor element and the cathode foil are stacked together, constituting a stack in which the cathode part of the capacitor element is electrically connected to the cathode foil. The package body contains an epoxy resin. The thickness of the package body located above or below the stack in a stacking direction of the stack is 24.9% or more of the thickness of the stack in the stacking direction.

### CROSS REFERENCE TO RELATED APPLICATION

The present application is a continuation application of International Application No. PCT/JP2024/030584, filed on Aug. 28, 2024 and claims priority with respect to the Japanese Patent Application No. 2023-138399 filed on Aug. 28, 2023. The entire contents of these prior applications are incorporated herein by reference.

### TECHNICAL FIELD

The present invention relates to an electrolytic capacitor.

### BACKGROUND

An electrolytic capacitor includes a capacitor element having an anode part and a cathode part, a package body sealing the capacitor element, and external electrodes electrically connected to the anode part and the cathode part of the capacitor element, respectively.

As a configuration of a solid electrolytic capacitor, Patent Literature 1 (JP2003-086459A) proposes “a solid electrolytic capacitor including: a capacitor element having a capacitance-forming portion; a package resin covering the capacitance-forming portion; an anode terminal and a cathode terminal each of which is at least partially disposed outside the package resin; and a lead, wherein the capacitor element includes an anode, a dielectric layer and a solid electrolyte layer stacked in this order on a part of the anode, the lead is electrically connected to the solid electrolyte layer, and in at least one connection portion selected from a connection portion between the anode and the anode terminal and a connection portion between the lead and the cathode terminal, a surface of at least one member selected from the anode and the lead has a roughened shape.”

In the solid electrolytic capacitor disclosed in Patent Literature 1, the lead is exposed outside the package resin, and a part of the exposed lead is electrically connected to the cathode terminal. According to Patent Literature 1, in the connection portion with the cathode terminal, the surface of the lead is processed to have an enlarged surface area, which makes it possible to obtain a solid electrolytic capacitor with low equivalent series resistance (ESR).

### SUMMARY

According to Patent Literature 1, it is possible to reduce the initial ESR of the solid electrolytic capacitor. However, the ESR may increase from the initial ESR due to a high-temperature treatment such as reflow. In Patent Literature 1, no consideration is given to this point.

The increase of ESR after reflow can occur, when sealing with the package resin is insufficient, due to the entry of air, water, and the like through an unfilled area of the package resin. Moreover, the package resin swells and deforms due to the stress caused by gas generation at high temperatures, and in association therewith, cracks occur, and the characteristics including ESR of the capacitor may degrade. Furthermore, in association with the swelling of the package resin, the metal foil (lead) and the capacitor element may be disbonded from each other, to increase the contact resistance, which may result in an increase of ESR.

In terms of suppressing the swelling of the package resin, one possible solution would be to use a resin material that hardly deform, as the package resin. However, such a resin material is often poor in sealing performance or poor in fluidity during molding, tending to cause an unfilled area of the package resin to occur in the sealing process.

On the other hand, by increasing the thickness of the package resin within the capacitor, the deformation of the package resin at high temperatures can be suppressed. However, it becomes difficult to obtain a solid electrolytic capacitor with high capacitance.

One aspect of the present invention relates to an electrolytic capacitor, including: a capacitor element having an anode part and a cathode part; a cathode foil electrically connected to the cathode part; and a package body sealing the capacitor element, wherein the capacitor element and the cathode foil are stacked together, constituting a stack in which the cathode part of the capacitor element is electrically connected to the cathode foil, the package body contains an epoxy resin, and a thickness of the package body located above or below the stack in a stacking direction of the stack is 24.9% or more of a thickness of the stack in the stacking direction.

Another aspect of the present invention relates to an electrolytic capacitor including: a capacitor element having an anode part in a foil form, and a cathode part; and a package body sealing the capacitor element, wherein an end face of the anode part is exposed from the package body, and the exposed portion is electrically connected to an external electrode, the package body contains an epoxy resin, and a thickness of the package body located above or below the capacitor element in a perpendicular direction to a principal surface of the anode part is 24.9% or more of a total thickness of the capacitor element in the perpendicular direction.

According to the present disclosure, it is possible to obtain an electrolytic capacitor having low ESR even after subjected to a reflow process.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE DRAWINGS

FIG. 1 A schematic sectional view of an electrolytic capacitor according to one embodiment of the present disclosure.

FIG. 2 A schematic sectional view showing an exemplary structure of the capacitor element.

FIG. 3 A schematic sectional view of an electrolytic capacitor according to another embodiment of the present disclosure.

FIG. 4 A schematic sectional view of an electrolytic capacitor according to yet another embodiment of the present disclosure.

FIG. 5 A schematic sectional view of an electrolytic capacitor according to yet another embodiment of the present disclosure.

FIG. 6 A schematic sectional view of an electrolytic capacitor according to yet another embodiment of the present disclosure.

### DETAILED DESCRIPTION

Embodiments of the present disclosure will be described below by way of examples, but the present disclosure is not limited to the examples described below. In the following description, specific numerical values and materials are exemplified in some cases, but other numerical values and other materials may be adopted as long as the effects of the present disclosure can be obtained. In the present specification, the phrase “a numerical value A to a numerical value B” means to include the numerical value A and the numerical value B, and can be rephrased as “a numerical value A or more and a numerical value B or less.” In the following description, when the lower and upper limits of numerical values related to specific physical properties, conditions, etc. are mentioned as examples, any one of the mentioned lower limits and any one of the mentioned upper limits can be combined in any combination as long as the lower limit is not equal to or more than the upper limit. When a plurality of materials are mentioned as examples, one kind of them may be selected and used singly, or two or more kinds of them may be used in combination.

The present disclosure encompasses a combination of matters recited in any two or more claims selected from plural claims in the appended claims. In other words, as long as no technical contradiction arises, matters recited in any two or more claims selected from plural claims in the appended claims can be combined.

The “electrolytic capacitor” may be rephrased as a “solid electrolytic capacitor,” and the “capacitor” may be rephrased as a “condenser”.

### [Electrolytic Capacitor]

An electrolytic capacitor according to one embodiment of the present invention includes a capacitor element. The form of the capacitor element is not particularly limited. The capacitor element has an anode part and a cathode part. The capacitor element includes, for example, an anode body, a dielectric layer, and a cathode layer. The anode part includes at least a part of the anode body. The cathode part includes the cathode layer.

The capacitor element is sealed with a package body. The package body is constituted of a sealing material. The sealing material may be a cured product of a thermosetting resin composition including an epoxy resin and the like. In this case, the package body contains an epoxy resin. Preferably, the package body contains an epoxy resin and a filler.

In one embodiment, the electrolytic capacitor includes a cathode foil electrically connected to the cathode part. A stack is configured in which the capacitor element and the cathode foil are stacked such that the cathode part of the capacitor element is electrically connected to the cathode foil. Within the stack, for example, the cathode foil has a protruding end portion that protrudes in one direction perpendicular to the stacking direction relative to the cathode part. The cathode foil may be a metal foil. The stack is sealed with a package body, with a part of the cathode foil (a portion including at least the end face of the protruding end portion) exposed from the package body. The electrical connection between the cathode part of the capacitor element and an external electrode (external cathode electrode) can be established via the exposed portion.

However, during a high-temperature treatment process such as reflow, the package body may deform so as swell. In association with the deformation, the cathode foil may be peeled off from the capacitor element, to impair the electrical connection between the capacitor element and the cathode foil in some cases. As a result, the ESR may increase in some cases after the reflow process.

In the electrolytic capacitor, a thickness T1 of the package body located above or below the stack in the stacking direction is 24.9% or more of a thickness T2 of the stack in the stacking direction (T1/T2>0.249). When the thickness T1 is 24.9% or more of the thickness T2, the peeling of the cathode foil due to expansion of the package body is significantly suppressed, as compared to when the thickness T1 is less than 24.9% of the thickness T2. Thus, the increase of ESR at high temperatures can be remarkably suppressed, and low ESR can be maintained even after the reflow process. The thickness T1 is preferably 25% or more of the thickness T2 (T1/T2>0.25).

The thickness T1 of the package body located above the stack may satisfy the above relationship with respect to the thickness T2 of the stack. The thickness T1 of the package body located below the stack may satisfy the above relationship with respect to the thickness T2 of the stack. Preferably, the above relationship is satisfied when the thicknesses of the package body located above and below the stack are each denoted by T1.

The upper limit of the thickness T1 of the package body is not particularly limited, and in terms of achieving high capacitance, may be 200% or less, 100% or less, or 50% or less of the thickness T2 of the stack.

Furthermore, by using an epoxy resin as a resin constituting the package body, cracks hardly occur even at high temperatures. Thus, the entry of air, water, and the like can be suppressed, and the deterioration in capacitor characteristics can be suppressed.

Preferably, the package body contains a filler having an average particle diameter of 12 μm to 32 μm. The proportion of the filler in the package body is 73 mass % or more and 84 mass % or less. In this case, the fluidity during molding of the package resin is favorable, and the occurrence of an unfilled area between the package body and the stack is suppressed. Thus, the sealing performance can be improved. As a result, the deterioration in capacitor characteristics due to the entry of air, water, and the like is further suppressed. Note that the average particle diameter here means a particle diameter (median diameter D50) at which the cumulative volume calculated from the smaller particle diameter in a volume-based particle diameter distribution reaches 50% of the total.

In the particle diameter distribution of the filler, a particle diameter D10 at which the cumulative volume calculated from the smaller particle diameter in a volume-based particle diameter distribution reaches 10% of the total may be, for example, 1 μm or more. In the particle diameter distribution of the filler, the particle diameter D90 at which the cumulative volume calculated from the smaller particle diameter in a volume-based particle diameter distribution reaches 90% of the total may be, for example, 35 μm or less.

In term of improving the fluidity during molding, the filler having a particle diameter in the range of 12 μm to 32 μm preferably accounts for 30% to 90% by volume of the total in the particle diameter distribution of the filler, and may account for 30% to 70% by volume of the total. The proportion of the filler is determined by integrating the volume-based filler particle diameter distribution, in the range where the particle diameter is 12 μm to 32 μm.

The average particle diameter D50 (and particle diameters D10 and D90) can be determined by observing a cross section of the package body with a scanning electron microscope (SEM), and analyzing the cross-sectional image. The outlines of individual filler particles in the cross-sectional image are identified, to determine an area Sf occupied by each filler particle in the cross-section. From the area Sf, a diameter Df (Df=8√(Sf/π³)) of an equivalent sphere, as a diameter corresponding to an average cross-sectional area of spheres, is calculated, to determine the distribution of the diameter Df. Assuming that each of the filler particles is spherical having a diameter Df, the volume-based particle diameter distribution of the filler is calculated, from which D50, D10, and D90 are derived. It is preferable to select at least 100 filler particles, to calculate the particle diameter distribution.

Epoxy resins are excellent in electrical insulation performance, water resistance performance, and chemical resistance performance, and can be used to easily control the glass transition temperature Tg of the resin and the hardness of the resin portion. Epoxy resins are typically obtained through a crosslinking reaction of a base resin which is a monomer or polymer (prepolymer) having an epoxy group, with a curing agent. The base resin is, although not particularly limited, preferably a polyaromatic epoxy resin, and may be a prepolymer, such as bisphenol-type epoxy resin, biphenyl-type epoxy resin, naphthalene-type epoxy resin, cresol novolac-type epoxy resin, and dicyclopentadiene-type epoxy resin. The polyaromatic epoxy resin is an epoxy resin having a plurality of aromatic rings in its main backbone. In particular, biphenyl-type epoxy resin and naphthalene-type epoxy resin have low viscosity at high temperatures and exhibit high fluidity during molding.

The curing agent is not particularly limited, and is selected as appropriate depending on the type of the base resin. Examples of the curing agent include: a polyfunctional- or polyaromatic-type novolac-based curing agent, such as phenol novolac; an acid anhydride-based curing agent, such as tetrahydrophthalic anhydride, and hexahydrophthalic anhydride; and an amine-based curing agent, such as ethylenediamine, and aromatic amine.

In particular, the epoxy resin preferably includes a biphenyl aralkyl-type resin, in terms of ease of molding, and sufficient strength obtained. More preferably, the epoxy resin may be a biphenyl aralkyl-type resin of polyaromatic type.

The linear expansion coefficient of the package body may be such that a linear expansion coefficient α1 is 13×10⁻⁶/° C. or more and 21×10⁻⁶/° C. or less, and a linear expansion coefficient α2 is 52×10⁻⁶/° C. or more and 74×10⁻⁶/° C. or less. Here, the linear expansion coefficient α1 is a linear expansion coefficient of the package body at a temperature lower than the glass transition temperature Tg of the resin (epoxy resin) contained in the package body. The linear expansion coefficient α2 is a linear expansion coefficient of the package body at a temperature higher than the glass transition temperature Tg of the resin (epoxy resin) contained in the package body. The linear expansion coefficients α1 and α2 are determined by a measurement in accordance with JIS K7197.

The glass transition temperature Tg of the epoxy resin is, for example, 110° C. or higher, and may be higher than that. The Tg may be, for example, 130° C. or lower. The glass transition temperature Tg depends on the crosslinking density and the structure of the epoxy resin. Therefore, the glass transition temperature Tg can be controlled by, for example, the types of the base resin and the curing agent, the blending ratio between the base resin and the curing agent, and the molecular weight of the base resin.

The moisture absorption percentage of the epoxy resin may be 0.23% or more and 0.34% or less. The moisture absorption percentage is determined by leaving the resin in an environment of 85° C. and 85% relative humidity for 72 hours, and calculating from a formula ((M₁−M₀)/M₀)×100(%), where the M₁ is a mass of the resin after leaving for 72 hours and the M₀ is a mass of the resin before testing. The shape of the resin at the time of measurement is set in the form of a sheet after curing.

The flexural modulus at 260° C. of the epoxy resin may be preferably 0.19 GPa or more and 0.25 GPa or less. The flexural modulus is measured in accordance with JIS K7171.

The package body may contain other resins other than the epoxy resin. Examples of other resins include phenolic resin, urea resin, polyimide resin, polyamide-imide resin, polyurethane resin, diallyl phthalate resin, and unsaturated polyester resin. When the package body contains other resins in addition to the epoxy resin, the ratio of the epoxy resin to the total of the epoxy resin and other resins may be 75% or more, may be 90% or more, and may be 95% or more by mass.

The filler is not particularly limited, and may be a known filler. For example, an electrically insulating filler, such as insulating particles and insulating fibers, is used. Examples of the insulating material that constitutes the insulating filler include an insulating compound, such as silica, alumina, aluminum nitride, and boron nitride, glass, and a mineral material (talc, mica, clay, etc.). The package body may contain these fillers singly or in combination of two or more kinds.

When the content ratio of the filler in the package body is high, the strength of the package body is enhanced, and the shrinkage rate during molding also is reduced. Furthermore, the moisture absorption performance is reduced, and the flame retardancy is enhanced. On the other hand, when the content ratio of the filler in the package body is low, the bonding performance of the package body to the capacitor element is enhanced, but the package body becomes less rigid, and prone to the deformation by heat. Moreover, when the content ratio of the filler is low, the fluidity during molding is favorable, and an unfilled area of resin hardly occurs. For example, in the case of including a stack having a plurality of capacitor elements, the gaps between the capacitor elements are easily filled with the resin. To realize these characteristics in a balanced manner, the content ratio of the filler in the package body is preferably in the range of 70 mass % to 90 mass %. The content ratio may be 73 mass % or more and 84 mass % or less.

Given that the content ratios of the filler in the package body are the same, when the particle diameter of the filler is smaller, the resin present between the filler particles can act as a buffer, serving to relax the stress. As a result, the stress that the whole package body can relax increases. Furthermore, when the particle diameter of the filler is small, the resin can easily fill the gaps in the stack. In this respect, the maximum particle diameter of the filler may be 50 μm or less (e.g., 35 μm or less). By setting the maximum particle diameter to 35 μm or less, the stress can be easily relaxed as described above. Here, the maximum particle diameter refers to the diameter of the largest particle among the filler particles contained in the package body. The maximum particle diameter is determined by photographing a cross section of the package body, randomly selecting 100 particles, and measuring a cross-sectional area of each particle. Among equivalent circles having the same area as the cross-sectional area of the corresponding individual particles, the diameter of the largest equivalent circle is determined as the maximum particle diameter.

In the electrolytic capacitor, a part of the cathode foil may be exposed from the package body, and the exposed portion may be electrically connected to an external electrode (external cathode electrode). According to this configuration, the ESR of the electrolytic capacitor can be reduced. For example, a part of the cathode foil may have a protruding end portion protruding in one direction perpendicular to the stacking direction of the capacitor element, and at least part of the protruding end portion including its end face can be electrically connected to the external electrode.

In this case, in association with the swelling deformation of the package body during a high-temperature treatment process such as reflow, the adhesion between the cathode foil and the package body may come off, to form a gap between the package body and the cathode foil in some cases. Air, water, and the like may enter through the gap, causing the ESR to increase in some cases. Furthermore, in association with the swelling deformation of the package body, the electrical connection between the end face of the cathode foil and the external electrode may be impaired, and the ESR may increase. However, as described above, by setting the thickness T1 of the package body to 24.9% or more of the thickness T2 of the stack, the swelling of the package body is suppressed, so that the increase of ESR at high temperatures can be significantly suppressed, and low ESR can be maintained even after the reflow process.

Likewise, a part of the anode part of the capacitor element may be exposed from the package body, and the exposed portion may be electrically connected to an external electrode (external anode electrode). The anode part of the capacitor element has a protruding end portion protruding in one direction perpendicular to the stacking direction, and at least part of the protruding end portion of the anode part including the end face can be electrically connected to the external electrode. The protruding end portion of the anode part may protrude in a direction different from the protruding direction of the protruding end portion of the cathode foil.

In this case, in association with the swelling deformation of the package body during a high-temperature treatment process such as reflow, the adhesion with the package body may come off at the protruding end portion of the anode part, to form a gap between the package body and the anode part. Air, water, and the like may enter through the gap, causing the ESR to increase in some cases. Furthermore, in association with the swelling deformation of the package body, the electrical connection between the end face of the protruding end portion of the anode part and the external electrode may be impaired, causing the ESR to increase. However, as described above, by setting the thickness T1 of the package body to 24.9% or more of the thickness T2 of the stack, the swelling of the package body is suppressed, so that the increase of ESR at high temperatures can be significantly suppressed, and low ESR can be maintained even after the reflow process.

The electrolytic capacitor may not necessarily include a cathode foil electrically connected to the cathode part of the capacitor element. Even in this case, by configuring such that a part of the anode part of the capacitor element is exposed from the package body, and the exposed portion is electrically connecting to an external electrode (external anode electrode), an electrolytic capacitor with low ESR can be realized. Furthermore, by setting the thickness T1 of the package body and the total thickness T2 of the capacitor element to satisfy the above-mentioned relationship, the swelling of the package body is suppressed, and therefore, the increase of ESR at high temperatures can be significantly suppressed.

In one embodiment, the electrolytic capacitor includes a capacitor element having an anode part in a foil form, and a cathode part, and a package body sealing the capacitor element. The end face of the anode part is exposed from the package body, and the exposed portion is electrically connected to an external electrode (external anode electrode). The package body contains the above-mentioned epoxy resin. The thickness T1 of the package body located above or below the capacitor element in a perpendicular direction to the principal surface of the anode part is 24.9% or more of the total thickness T2 of the capacitor element in the perpendicular direction. In the case of including a stack in which a plurality of capacitor elements are stacked together, the perpendicular direction to the principal surface of the anode part can be the stacking direction of the plurality of the capacitor elements. In the case of including a stack in which a plurality of capacitor elements are stacked together, the total thickness T2 means the thickness of the stack in the perpendicular direction (i.e., the sum of the thicknesses of the plurality of capacitor elements in the stacking direction).

The stack may be configured to include a plurality of capacitor elements. In this case, the stack may include a plurality of cathode foils. Between the capacitor elements adjacent to each other, a cathode foil can be interposed. The cathode foil may electrically connect the cathode part of one of the adjacent capacitor elements, to the cathode part of the other one of the adjacent capacitor elements. A part of the anode part of each of the capacitor elements may be exposed from the package. End faces of a plurality of the anode parts may be exposed from the package body, and at least part of these end faces of the anode parts may be electrically connected to an external electrode (external anode electrode). A part of at least one of a plurality of the cathode foils may be exposed from the package. End faces of a plurality of the cathode foils may be exposed from the package body, and at least part of these end faces of the cathode foils may be electrically connected to an external electrode (external cathode electrode).

In the stack, a plurality of the capacitor elements may be all oriented in the same direction, and may be oriented in different directions. For example, the capacitor elements may be stacked such that the anode part and the cathode part are alternately oriented in opposite directions, the anode part and the cathode part are oriented in opposite directions in the desired order, the anode part and the cathode part alternately intersect with each other at 90 degrees, and the anode part and the cathode part intersect with each other at 90 degrees in the desired order.

Only the end faces of the anode parts may be exposed from the package body and electrically connected to an external electrode. Only the end faces of the cathode foils may be exposed from the package body and electrically connected to an external electrode. However, in order to achieve low ESR, it is preferable to expose both the end faces of the anode parts and the end faces of the cathode foils from the package body and electrically connect each to the corresponding external electrode.

The end faces of the cathode foils may be exposed from a first principal surface of the package body. In this case, the external electrode can be disposed so as to cover the first principal surface. In this case, the end faces of the anode parts may be exposed from a second principal surface of the package body different from the first principal surface (e.g., on the opposite side to the first principal surface).

When the stack includes a plurality of cathode foils, some of the end faces of a plurality of the cathode foils may be exposed from the first principal surface of the package body, and the rest of the end faces of the cathode foils may be exposed from a second principal surface of the package body different from the first principal surface (e.g., on the opposite side of the first principal surface). In this case, two external electrodes (external cathode electrodes) are included, with one disposed so as to cover the first principal surface, and the other disposed so as to cover the second principal surface. In this case, the end faces of the anode parts may be exposed from a third principal surface of the package body different from the first and second principal surfaces. In this case, the external electrode (external anode electrode) may be disposed so as to cover the third principal surface.

Likewise, when the stack includes a plurality of capacitor elements, some of the end faces of a plurality of anode parts may be exposed from the third principal surface of the package body, and the rest of the end faces of the anode parts may be exposed from a fourth principal surface of the package body different from the first to third principal surfaces (e.g., on the opposite side to the third principal surface). In this case, two external electrodes (external anode electrodes) are included, with one disposed so to cover the third principal surface and the other disposed so as to cover the fourth principal surface.

The size of the electrolytic capacitor is not particularly limited. The dimension of the electrolytic capacitor in the stacking direction of the stack may be 100 μm or more and 10 mm or less, and may be 300 μm or more and 5 mm or less. In this case, sufficient rigidity is obtained, and the effect of suppressing the increase of ESR at high temperatures by setting the thickness T1 of the package body to 24.9% or more of T2 is high.

Next, an illustrative description will be given of a method for producing an electrolytic capacitor. A method for producing an electrolytic capacitor according to the present disclosure, however, is not limited to the following.

The method for producing an electrolytic capacitor includes, for example, a step of preparing a capacitor element including an anode part and a cathode part, a step of obtaining a stack by stacking a cathode foil on the cathode part of the capacitor element, a step of sealing the capacitor element with a package body, a step of exposing an end face of the cathode foil from the package body, and a step of forming an external cathode electrode electrically connected to the cathode part via the end face of the cathode foil.

The above production method may further include a step of exposing an end face of the anode part from the package body, and a step of forming an external anode electrode electrically connected to the end face of the anode part. Each step will be described below in detail.

### (Step of Preparing Capacitor Element)

The step of preparing a capacitor element includes a step of preparing an anode body. The step of preparing a capacitor element may also include a step of disposing a separation layer (insulating member) on a part of the anode body.

### (Anode Body)

In the step of preparing an anode body, an anode body provided with a first portion (which may be referred to as an “anode leading portion”) including a first end, and a second portion (which may be referred to as a “cathode forming portion”) including a second end is prepared. The anode part includes the first portion (anode leading portion) of the anode body. The first portion of the anode body can include an end-to-be-removed portion that is to be removed later by shaving or the like. At least the second portion of the anode body has a porous portion. A dielectric layer is formed later at least on the surface of the second portion.

The anode body includes a valve metal, an alloy containing a valve metal, and a compound containing a valve metal (intermetallic compound, etc.). These materials can be used singly or in combination of two or more kinds. As the valve metal, aluminum, tantalum, niobium, titanium, and the like can be used. The anode body may be a foil (anode foil) of a valve metal, an alloy containing a valve metal, or a compound containing a valve metal, and may be a porous sintered body of a valve metal, an alloy containing a valve metal, or a compound containing a valve metal.

When a foil (anode foil) is used for the anode body, a porous portion is formed in the surface layer of at least the second portion of the anode foil. That is, the second portion has a metal core portion and a porous portion formed on the surface of the metal core portion. The porous portion may be formed by roughening at least the surface of the second portion of the anode foil, by etching or other methods. The roughening treatment such as etching treatment may be performed after placing a predetermined masking member on the surface of the first portion. The roughening treatment such as etching treatment may be applied to the entire surface of the anode foil. In the former case, an anode foil having a porous portion on the surface of the second portion, without having a porous portion on the surface of the first portion, is obtained. In the latter case, a porous portion is formed, in addition to on the surface of the second portion, also on the surface of the first portion.

For the etching treatment, any known method may be used, and, for example, electrolytic etching can be used. Any masking member can be used, and an insulator such as resin is preferably used. The masking member may be a conductor containing a conductive material.

When the entire surface of the anode foil is subjected to a roughening treatment, a porous portion will be present also on the surface of the first portion. The porous portion of the first portion may be compressed in advance, so that the pores are crushed. This suppresses the entry of air and water into the electrolytic capacitor through the porous portion from the end face of the anode part exposed from the package body.

When a sintered body is used for the anode body, the sintered body can be obtained by compacting a powder containing a valve metal (e.g., a powder of a valve metal, or a powder of an alloy or compound containing a valve metal), followed by sintering. For example, a powder of a valve metal is placed, together with an anode wire to be connected to the anode body, in a mold such that an embedding portion of the anode wire is embedded in the powder, and then pressure-molded, and sintered. This can provide a porous anode body with a part of the anode wire extended upright therefrom. The sintering is preferably performed under reduced pressure. The metal wire corresponds to the first portion, and the sintered body corresponds to the second portion.

### (Separation Layer)

When a foil (anode foil) is used for the anode body, a separation layer with insulating properties may be provided, in order to electrically separate the first portion from the second portion. In this process, an insulating member is placed via a dielectric layer on the first portion of the anode body. The insulating member is disposed so as to isolate the first portion from the cathode part which is to be formed in a later process. The separation layer can be provided adjacent to the cathode part, so as to cover at least part of the surface of the first portion.

The separation layer can be obtained by, for example, attaching a sheet-like insulating member (resin tape, etc.) to the first portion. In the case of using an anode foil having a porous portion on its surface, the porous portion of the first portion may be compressed and flattened before attaching the insulating member to the first portion. The sheet-like insulating member preferably has an adhesive layer on the surface on the side to be attached to the first portion.

A liquid resin may be applied onto or impregnated into the first portion, to form an insulating member that adheres to the first portion. According to the method using a liquid resin, the insulating member is formed so as to fill the irregularities on the surface of the porous portion of the first portion. The liquid resin easily enters into the recesses on the surface of the porous portion, and the insulating member can be easily formed even within the recesses.

### (Dielectric Layer)

The dielectric layer is formed by, for example, anodizing the valve metal on at least the surface of the second portion of the anode body by chemical conversion treatment or other methods. The chemical conversion treatment can be performed by, for example, immersing the anode body in a chemical conversion solution, to impregnate the surface of the anode body with the chemical conversion solution, and applying a voltage between the anode body as the anode and a cathode immersed in the chemical conversion solution. When the anode body has a porous portion on its surface, the dielectric layer is formed along the irregular contour of the surface of the porous portion. The dielectric layer contains an oxide of a valve metal. For example, the dielectric layer formed using aluminum as a valve metal contains aluminum oxide. The dielectric layer formed using tantalum as a valve metal contains tantalum oxide. The dielectric layer is formed along at least the surface of the second portion where the porous portion is formed (including the inner wall surfaces of the pores of the porous portion). The method of forming a dielectric layer is not limited to the above, and any method can be adopted as long as an insulating layer that functions as a dielectric is formed on the surface of the second portion. The dielectric layer may be formed also on the surface of the first portion (e.g., on the porous portion of the surface of the first portion).

### (Cathode Part)

The cathode part includes a solid electrolyte layer covering at least part of the dielectric layer, and a cathode leading layer covering at least part of the solid electrolyte layer.

### (Solid Electrolyte Layer)

The solid electrolyte layer contains, for example, a conductive polymer. As the conductive polymer, polypyrrole, polythiophene, polyaniline, derivatives of them, and the like can be used. The solid electrolyte layer can be formed by, for example, chemically polymerizing and/or electrolytically polymerizing a raw material monomer on the dielectric layer. Alternatively, it can be formed by applying a solution or dispersion of a conductive polymer onto the dielectric layer. The solid electrolyte layer may contain a manganese compound.

### (Cathode Leading Layer)

The cathode leading layer has, for example, a carbon layer and a conductive paste layer. The carbon layer is electrically conductive, and can be constituted using a conductive carbon material such as graphite. The carbon layer can be formed by, for example, applying a carbon paste onto at least part of the surface of the solid electrolyte layer. The conductive paste layer may be a cured product (metal paste layer) of a metal paste containing metal particles and a resin. The metal particles can be particles of silver, copper, nickel, or other metals. Silver is particularly preferred. That is, the metal paste layer is desirably a silver paste layer. The resin desirably include an epoxy resin. The metal paste may be a thermosetting resin composition containing metal particles and an epoxy resin. The metal paste layer is formed by, for example, application onto the surface of the carbon layer. The configuration of the cathode leading layer is not limited to the above, and may be any configuration that has a current collecting function. The conductive paste layer may be a cured product of a conductive carbon material paste containing carbon particles and a resin.

### (Step of Obtaining Stack)

Next, a stack is obtained by stacking a cathode foil on the cathode part of the capacitor element. A stack may be obtained by stacking a plurality of capacitor elements and/or a plurality of cathode foils together. The cathode foil is electrically connected to the cathode leading layer, and is to be electrically connected to an external cathode electrode.

In the case of obtaining a stack having a plurality of capacitor elements, the cathode foil can be interposed between the cathode leading layer of one of the capacitor elements and the cathode leading layer of the other capacitor element adjacent thereto. However, this is not a limitation, and the cathode leading layers of some of the capacitor elements may be directly connected to the cathode leading layer of the capacitor element adjacent thereto, without the cathode foil interposed therebetween.

### (Cathode Foil)

The cathode foil is, for example, a metal foil, and may be a sintered foil, a vapor-deposited foil, or an applied foil. The cathode foil may be a sintered foil, a vapor-deposited foil, or an applied foil which is a metal foil (e.g., Al foil, Cu foil) coated with a conductive film by vapor deposition or application. The vapor-deposited foil may be an Al foil with Ni vapor-deposited on its surface. Examples of the conductive film include Ti, TiC, TiO, and C (carbon) films. The conductive film may be a carbon applied film.

### (Substrate)

The electrolytic capacitor may include a substrate supporting one capacitor element or a stack having a plurality of capacitor elements. The substrate is, for example, an insulating substrate. In the case where electrical separation between the external anode electrode and the external cathode electrode can be ensured, the substrate may be a metal substrate or a printed circuit board with a wiring pattern applied.

When the substrate is an insulating substrate, one capacitor element or a stack having a plurality of capacitor elements may be mounted on the substrate using an adhesive (e.g., an epoxy-based adhesive).

When the substrate is a metal substrate or the like, a metal foil may be disposed between the substrate and the cathode part of one capacitor element, or a metal foil may be disposed between the substrate and the cathode part of the capacitor element closest to the substrate within the element stack. In this case, the metal foil may be bonded to the cathode part and the substrate using a conductive adhesive. In this case, a conductive adhesive layer is formed not only between the metal foil and the cathode part but also between the metal foil and the substrate. The conductive adhesive layer may include a first layer interposed between the cathode part and the principal surface of the metal foil facing the cathode part, a second layer interposed between the substrate and the principal surface of the metal foil facing the substrate, and a third layer packed into the through-holes in the metal foil and is integrally formed with the first and second layers. The presence of the third layer improves the bonding strength between the cathode part and the metal foil, and the bonding strength between the substrate and the metal foil.

Examples of the insulating substrate include a glass epoxy substrate, a paper phenolic substrate, a glass polyimide substrate, and a fluorine substrate. The thickness of the insulating substrate is, for example, 500 μm or less, may be 250 μm or less, and may be 200 μm or less, or 150 μm or less. The thickness of the insulating substrate may be, for example, 50 μm or more.

The substrate may include a coating film covering at least one of the principal surfaces of the insulating substrate. The coating film may include at least one of a cured product of a curable resin (e.g., an epoxy resin) and a thermoplastic resin (e.g., a fluorocarbon resin). Examples of the epoxy resin include those exemplified above. Examples of the fluorocarbon resin include polytetrafluoroethylene, perfluoroalkoxyalkane, perfluoroethylenepropene copolymer, polyvinylidene fluoride, and vinylidene fluoride copolymer.

(Step of Sealing Capacitor Element with Package Body)

First, the package body may be formed by placing a capacitor element in a mold configured such that the end face of the anode part and the end face of the cathode part are exposed and the remainder of the capacitor element is sealed, and then, sealing the capacitor element with a sealing material. Second, the package body may be formed by placing a capacitor element in a mold configured such that the entire capacitor element is sealed without exposing the end face of the anode part and the end face of the cathode part, and then, sealing the capacitor element with a sealing material. In either case, it is efficient to prepare an assembly of a plurality of capacitor elements, and then, seal the assembly with a sealing material, to form a package body. Such a process can be performed by transfer molding, compression molding, or other methods. In the first method, a step of exposing the end face of the anode part and the end face of the cathode part from the package body is concurrently performed.

The sealing material preferably includes, for example, a thermosetting resin composition, and may contain a thermoplastic resin. In transfer molding or compression molding, an uncured sealing material is cured, into the package body. The thermosetting resin composition may contain, in addition to the base resin such as epoxy resin, a filler, a curing agent, a polymerization initiator, a catalyst, and the like.

The capacitor element is sealed with a sealing material such that the thickness of the package body above or below the stack in the stacking direction of the stack is 24.9% or more of the thickness of the stack in the stacking direction.

(Step of Exposing End Face of Cathode Foil or Anode Part from Package Body)

In the case of exposing the end face of the cathode foil from the package body, for example, a part of the package body may be removed. Specifically, after covering the capacitor element with a package body, the package body may be polished or partially removed so that the end face of the cathode foil is exposed from the package body. A part of the cathode foil may be removed together with a part of the package body.

In the case of exposing the end face of the anode part from the package body, too, the package body may be partially removed so that the end face of the anode part is exposed from the package body. As the method for exposing the end face of the anode part from the package body, a similar method used for exposing the end face of the cathode foil from the package body can be used. A part of the first portion may be removed together with a part of the package body. The surface of the package body where the end face of the first end of the anode part is exposed is preferably different from the surface where the end face of the cathode foil is exposed from the package body.

The anode body of the stack and the insulating member may be partially removed together with the package body, so that the end face of the first end and the end face of the insulating member are exposed from the package body. This forms end faces flush with each other exposed from the package body, on the anode body and the insulating member. In this way, the end face of the anode body and the end face of the insulating member which are flush with the surface of the package body can be both exposed easily from the package body.

As described above, by shaving or the like, the end face of the anode body (first end) with no natural oxide layer formed thereon and the end face of the cathode foil can be easily exposed from the package body, and a low-resistance and highly reliable connection can be obtained between the anode body or the first portion and the external anode electrode.

In the case of forming the package body by preparing stacks of a plurality of capacitor elements and sealing the assembly of them with a sealing material, when singulating the assembly, the joint portion joining the anode parts adjacent to each other in the assembly, and the joint portion joining the cathode foils adjacent to each other may be cut. In this case, on the cut surface, the end faces of the anode part or the cathode foil are exposed. Such a cut surface may be a dry-etched surface processed using plasma or the like.

### (Contact Layer)

The end face exposed from the package body of at least one of the anode part and the cathode part may be connected to an external electrode via a contact layer. The contact layer may be formed of, for example, an electroless Ni-plated layer, and may be formed of an electroless Ni-plated layer and an electroless Ag-plated layer covering thereon. When a contact layer is provided, the electrical connection between the end face of the anode or cathode part and the external electrode can be ensured more reliably by the contact layer, which is advantageous for improving the reliability of the solid electrolytic capacitor.

The contact layer may be selectively formed so as not to cover the surface of the package body as much as possible, and cover only the end face exposed from the package body of the anode or cathode part. A zincate treatment may be performed prior to the formation of an electroless Ni-plated layer, so that the electroless Ni-plated layer is selectively formed on the end face of the anode or the cathode part.

### (Step of Forming External Cathode Electrode or External Anode Electrode)

The external electrode usually includes a first external electrode (external anode) connected to the anode part, and a second external electrode (external cathode) connected to the cathode part. When the anode part includes an anode body provided with a dielectric layer, the anode body (second portion) may have a second end face exposed from the package body, and the second end face may be electrically connected to the second external electrode. Each of the external electrodes may include a metal layer. The metal layer is, for example, a plating layer. The metal layer includes, for example, at least one metal selected from the group consisting of nickel (Ni), copper (Cu), zinc (Zn), tin (Sn), silver (Ag), and gold (Au). For the formation of the metal layer, for example, a film formation technique, such as electrolytic plating, electroless plating, sputtering, vacuum vapor deposition, chemical vapor deposition (CVD), cold spraying, or thermal spraying, may be used.

Each of the external electrodes may include, for example, a laminated structure of a Ni layer and a tin layer. The outer surface of each of the external electrodes is preferably a metal with excellent solder wettability. Examples of such a metal include Sn, Au, Ag, and Pd.

Each of the external electrodes may include, for example, a laminated structure of a conductive paste layer and a plating layer. In terms of its excellent solder wettability, a plating layer having the above-mentioned laminated structure of a Ni layer and a tin layer (Ni/Sn plating layer, etc.) may be adopted as the plating layer.

In order to form a plating layer with sufficient thickness and allow for easy formation of a plating layer on the exposed surface of the package body, a conductive layer may be formed before forming a plating layer, and then, a plating layer may be formed on the conductive layer. The conductive layer may be a conductive paste layer. The conductive paste layer may be formed so as to cover the end face of at least one of the anode part and the cathode part of the capacitor element or a plurality of the capacitor elements. In this case, the conductive paste layer may be formed so as to cover the end face via the contact layer. The conductive paste layer may be formed so as to cover not only the end face of the anode part or the cathode part, but also the surface (e.g., side surface) of the package body where this end face is exposed. In this way, the anode part or the cathode part of the capacitor element is electrically connected to the conductive paste layer.

The conductive paste layer can be formed by applying a conductive paste containing conductive particles and a resin material onto the surface of the package body where the end face of the anode part or the cathode part is exposed, followed by drying. Therefore, the conductive paste layer can also be referred to as a conductive resin layer containing conductive particles. The resin material is suitable for bonding with the package body and the contact layer, and its bonding strength can be enhanced through chemical bonding (e.g., hydrogen bonding). As the conductive particles, for example, metal particles such as silver and copper, and particles of a conductive inorganic material such as carbon can be used.

The conductive paste layer may cover not only the surface (e.g., side surface) of the package body where the end face of the anode body or the cathode body of the capacitor element is exposed, but also a part of the surface (e.g., top or bottom surface) intersecting with this surface. Furthermore, when the surface of the substrate constitutes part of the outer surface of the capacitor element, the conductive paste layer may cover part of the surface of the substrate.

A lead frame covering at least part of the conductive layer may be used to form an external electrode. In order to establish a strong electrical connection between the lead frame and the conductive layer, a solder layer or another conductive layer may be formed between the conductive layer and the lead frame.

Specific configurations of the electrolytic capacitor according to embodiments of the present disclosure will be illustrated below with reference to the drawings. The electrolytic capacitor according to the present disclosure, however, is not limited thereto.

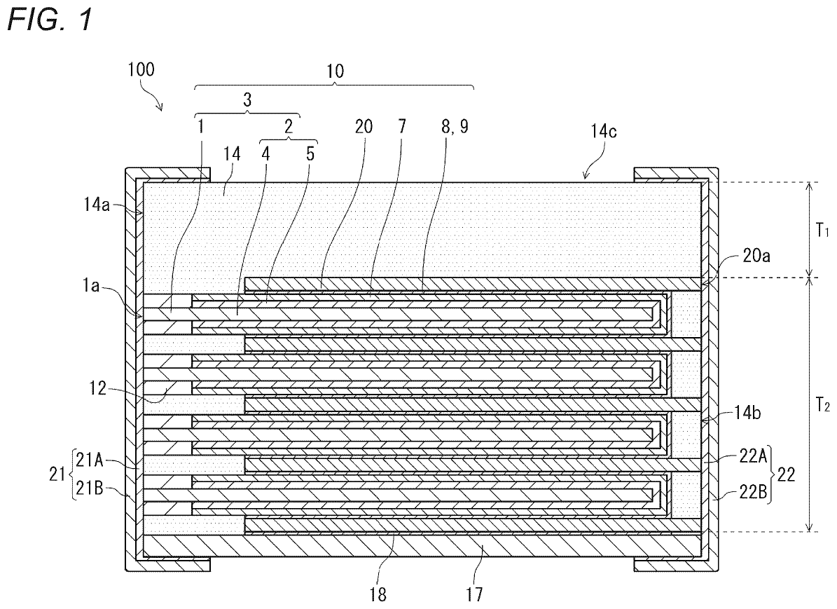

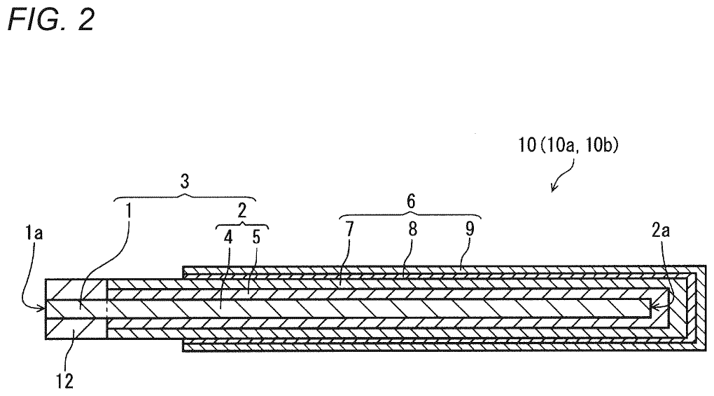

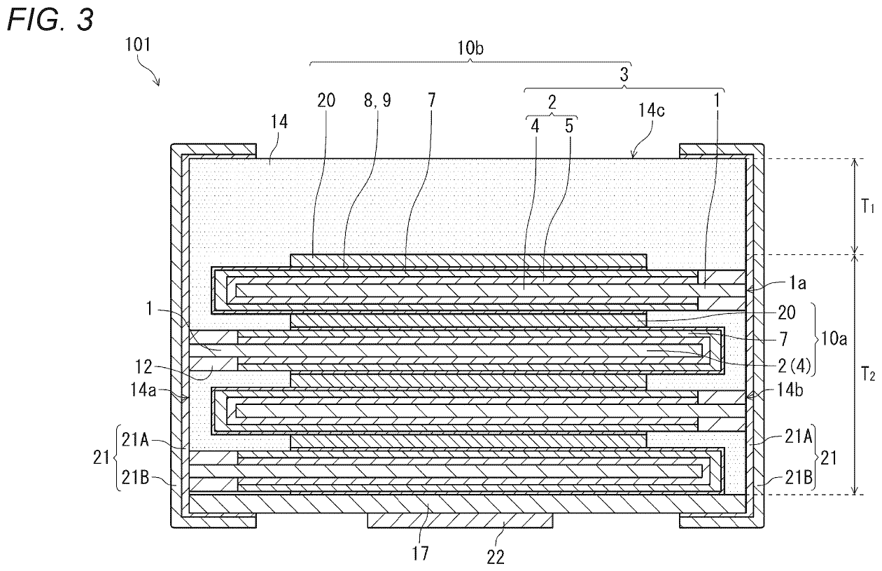

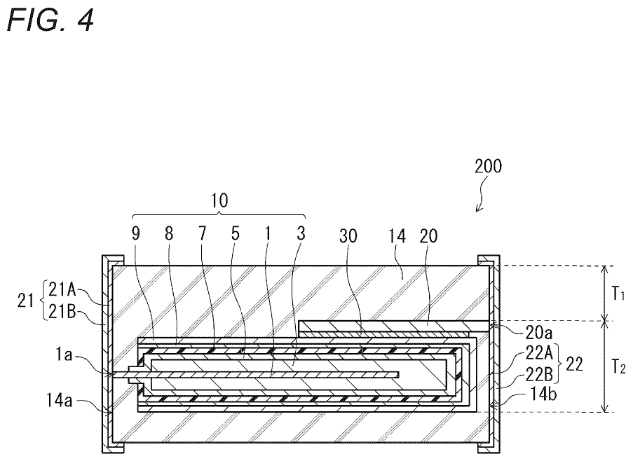

FIG. 1 is a schematic sectional view of an electrolytic capacitor according to one embodiment. FIG. 2 is a schematic sectional view showing an exemplary structure of the capacitor element. FIG. 3 is a schematic sectional view of an electrolytic capacitor according to another embodiment of the present disclosure. FIGS. 4, 5, and 6 are each a schematic sectional view of an electrolytic capacitor according to yet another embodiment of the present disclosure.

### First Embodiment

As illustrated in FIG. 1, an electrolytic capacitor 100 includes a plurality of capacitor elements 10, a package body 14 sealing the capacitor elements 10, a plurality of cathode foils 20, a first external electrode (external anode electrode) 21, and a second external electrode (external cathode electrode) 22. A plurality of the capacitor elements 10 and the cathode foils 20 are stacked together, constituting a stack.

Each of the capacitor elements 10 includes an anode body 3 and a cathode part 6. The anode body 3 is an anode foil. The anode body 3 has a metal core portion 4 and a porous portion 5, and a dielectric layer (not shown) is formed on at least part of the surface of the porous portion 5. The cathode part 6 covers at least part of the dielectric layer. Each of the cathode foils 20 is electrically connected to the cathode part 6 of the capacitor element.

In the capacitor element 10, on an end face 1a at one end (first end), the anode body 3 is exposed without being covered with the cathode part 6, while an end face 2a at the other end (second end) is covered with the cathode part 6. The portion of the anode body 3 not covered with the cathode part is a first portion 1, and the portion of the anode body 3 covered with the cathode part is a second portion 2. The end of the first portion 1 is the first end, and the end of the second portion 2 is the second end. The dielectric layer is formed on the surface of the porous portion 5 formed at least in the second portion 2. The first portion 1 of the anode body 3 may be called an anode leading portion. The second portion 2 of the anode body 3 may be called a cathode forming portion.

More specifically, the second portion 2 has the metal core portion 4 and the porous portion 5 which is formed on the surface of the metal core portion 4 by roughening (etching etc.). On the other hand, the first portion 1 may or may not have the porous portion 5 on its surface. The dielectric layer is formed along the surface of the porous portion 5. At least part of the dielectric layer covers inner wall surfaces of the pores of the porous portion 5 and is formed along the inner wall surfaces.

The cathode part 6, which is a cathode layer, includes a solid electrolyte layer 7 covering at least part of the dielectric layer, and cathode leading layers 8, 9 covering at least part of the solid electrolyte layer 7. The surface of the dielectric layer has irregularities formed according to the contour of the surface of the anode body 3. The solid electrolyte layer 7 can be formed so as to fill such irregularities on the dielectric layer. The cathode leading layer includes, for example, a carbon layer 8 covering at least part of the solid electrolyte layer 7, and a conductive paste layer 9 covering the carbon layer 8. The conductive paste layer 9 can be, for example, a silver paste layer containing silver particles as metal particles.

The cathode foil 20 is interposed between the cathode leading layers 8, 9 of the capacitor element 10 and the cathode leading layers 8, 9 of the capacitor element adjacent thereto in the stacking direction of the element stack. The cathode foil 20 is shared between the capacitor elements 10 adjacent to each other in the stacking direction of the stack. A conductive adhesive layer may be interposed between the cathode foil 20 and the capacitor element 10. For the adhesive layer, for example, a conductive adhesive is used. The adhesive layer contains, for example, silver. The adhesive layer can be a silver paste layer similar to the conductive paste layer 9.

The portion of the anode body 3 on which the solid electrolyte layer 7 is formed via the dielectric layer can be regarded as the second portion 2, and the portion of the anode body 3 on which the solid electrolyte layer 7 is not formed can be regarded as the first portion 1.

In a region not facing the cathode layer of the anode body 3, at least on a portion adjacent to the cathode layer, a separation layer 12 with insulating properties (or insulating member) can be formed so as to cover the surface of the anode body 3. This regulates the contact between the cathode part 6 and the exposed portion (first portion 1) of the anode body 3. The separation layer 12 is, for example, an insulating resin layer.

The structure sealed with the package body 14 has a substantially rectangular parallelepiped outer shape, and the electrolytic capacitor 100 also has a substantially rectangular parallelepiped outer shape. The package body 14 has a first principal surface 14a, a second principal surface 14b opposite the first principal surface 14a, and a top surface 14c that is continuous with the first and second principal surfaces 14a and 14b and intersects therewith in the stacking direction of the stack. In the element stack, the first end portions 1a of the capacitor elements 10 are exposed on the first principal surface 14a.

The end faces 1a of a plurality of the first end portions (first portions) exposed from the package body 14 are all electrically connected to a first external electrode 21 extending along the first principal surface 14a. In this case, the proportion of the first portions in the anode body can be reduced, and high capacitance can be achieved. Furthermore, the contribution of the ESR and ESL due to the first portion is reduced.

Also, end faces 20a of the cathode foils 20 are exposed from the package body 14 on the second principal surface 14b. The end faces of the cathode foils 20 exposed from the package body 14 are all electrically connected to a second external electrode 22 extending along the second principal surface 14b.

The first external electrode 21 includes, for example, a silver paste layer 21A, and a Ni/Sn plating layer 21B. The silver paste layer 21A covers the end faces of the first end portions 1a and the first principal surface 14a (first surface) of the package body 14. The Ni/Sn plating layer 21B covers the silver paste layer 21A. The second external electrode 22 includes a silver paste layer 22A and a Ni/Sn plating layer 22B. The silver paste layer 22A covers the end faces of the cathode foils 20 and the second principal surface 14b (second surface) of the package body 14. The Ni/Sn plating layer 22B covers the silver paste layer 22A.

In FIG. 1, the end faces of the first ends 1a are flush with the first principal surface 14a. Also, in FIG. 1, the end faces 20a of the cathode foils 20 are flush with the second principal surface 14b. However, the end faces of the first ends 1a and the end faces 20a of the cathode foil 20 may not necessarily be flush with the principal surface of the package body 14. The end faces of the first ends 1a may be protruded or recessed with respect to the first principal surface 14a. Likewise, the end faces 20a of the cathode foils 20 may be protruded or recessed with respect to the second principal surface 14b.

In the electrolytic capacitor illustrated in FIG. 1, the thickness T1 of the package body located above the stack in the stacking direction is 24.9% or more of the thickness T2 of the stack in the stacking direction (T1/T2>0.249). By setting as above, even when the electrolytic capacitor is exposed to high temperatures during reflow or the like, the cathode foil 20 and the cathode leading layer 9 are unlikely to be disbonded from each other due to the swelling deformation of the package body, so that the increase of ESR is suppressed, and low ESR can be maintained. In the example of FIG. 1, the thickness T1 refers to the minimum value of the distance from the stack to the top surface 14c of the package body 14.

The stack is supported on a substrate 17. The substrate may be, for example, an insulating substrate, and may be a metal substrate or a printed circuit board with a wiring pattern applied, as long as electrical separation between the first external electrode 21 and the second external electrode 22 can be ensured. A cathode foil may be disposed between the substrate 17 and the cathode leading layer located on the lowermost surface of the element stack. The substrate 17 may be, for example, a laminated substrate with a conductive wiring pattern formed on its front and back sides, and the wiring patterns on the front and back sides may be electrically connected to each other via through-holes. The wiring pattern on the front side is electrically connected to the cathode part 6 of the capacitor element stacked at the lowermost layer, and the wiring pattern on the back side can be electrically connected to a third external electrode (not shown). In this case, via the substrate 17, electrical connection between the third external electrode and the cathode parts 6 of the capacitor elements of the element stack is established. Depending on the wiring pattern on the back side, the third external electrode (cathode) can be disposed as desired in the central region on the bottom surface of the electrolytic capacitor. For example, by disposing the third external electrode close to the first external electrode, the ESL can be reduced.

The substrate 17 may be a metal plate, and may have a lead frame structure in which a metal plate processed into a predetermined shape is bent. The metal plate is partially exposed from the package body, and electrically connected at the exposed portion to an external terminal.

### Second Embodiment

FIG. 3 is a schematic sectional view of an electrolytic capacitor according to another embodiment of the present disclosure. An electrolytic capacitor 101 illustrated in FIG. 3 includes a plurality of capacitor elements 10a and 10b, a package body 14 sealing the capacitor elements 10a and 10b, first external electrodes (external anode electrodes) 21, and a second external electrode (external cathode electrode) 22. The plurality of the capacitor elements 10a and 10b are stacked together, constituting an element stack. Two first external electrodes 21 are disposed apart from each other, with one of the first external electrodes 21 covering a first principal surface 14a of the package body 14 and the other first external electrode 21 covering a second principal surface 14b of the package body 14.

The plurality of capacitor elements include first capacitor elements 10a, in each of which the direction toward a second portion 2 from a first portion 1 of an anode body 3 is a first direction, and second capacitor elements 10b, in each of which the direction toward the second portion 2 from the first portion 1 of the anode body 3 is a second direction opposite the first direction. End faces 1a of the first ends of the first capacitor elements 10a are exposed from the package body 14 at the first principal surface 14a and are electrically connected to one of the first external electrodes 21. End faces 1a of the first ends of the second capacitor elements 10b are exposed from the package body 14 at the second principal surface 14b and are electrically connected to the other one of the first external electrode 21. Although not shown, at a third principal surface intersecting the first and second principal surfaces 14a and 14b and/or a fourth principal surface opposite the third principal surface, an end face of a cathode foil 20 is exposed from the package body 14 and is electrically connected to the second external electrode 22.

In the electrolytic capacitor 101, the direction of the current flowing in the element is different between the first capacitor elements 10a and the second capacitor elements 10b. Therefore, the direction of the magnetic field generated by the current is different therebetween, and this decreases the magnetic flux generated within the element stack. This makes it possible to reduce the ESL.

In the example of FIG. 3, the first capacitor element 10a and the second capacitor element 10b are alternately stacked within the element stack. However, the first capacitor element 10a and the second capacitor element 10b may not be necessarily stacked alternately. The element stack may have, in a part thereof, a section where the first capacitor elements 10a are stacked adjacent to each other in the same direction, and/or a section where the second capacitor elements 10b are stacked adjacent to each other in the same direction. When the first capacitor element and the second capacitor element are alternately stacked even in only a part, this can effectively decrease the magnetic flux generated within the element stack, to effectively reduce the ESL, and therefore, is preferable.

In the electrolytic capacitor illustrated in FIG. 3, the thickness T1 of the package body located above the stack in the stacking direction (the perpendicular direction to the principal surface of the anode body 3 which is foil) is 24.9% or more of the thickness T2 of the stack in the stacking direction (T1/T2>0.249). By setting as above, even when the electrolytic capacitor is exposed to high temperatures during reflow or the like, the cathode foil 20 and the cathode leading layer 9 are unlikely to be disbonded from each other due to the swelling deformation of the package body, so that the increase of ESR is suppressed, and low ESR can be maintained.

### Third Embodiment

FIG. 4 is a schematic sectional view of an electrolytic capacitor according to yet another embodiment of the present disclosure. A capacitor element 10 includes an anode body 3, which is a sintered body of metal particles, and a metal wire 1 with a part thereof embedded in the anode body 3. The metal wire 1 corresponds to the first portion, and the sintered body corresponds to the second portion. Therefore, the end face of the anode part is an end face 1a of the tip end of the metal wire 1. A dielectric layer 5 is formed on at least part of the surface of the anode body 3. A cathode part 6 covers at least part of the dielectric layer 5. The cathode part 6 includes a solid electrolyte layer 7 and a cathode leading layer.

The anode body 3 can be obtained by molding a powder containing a valve metal, followed by sintering. For example, a valve metal powder is placed, together with the metal wire 1 to be connected to the anode body 3, in a mold such that an embedding portion of the metal wire is embedded in the powder, and then, pressure-molded, and sintered. This can provide a porous anode body 3 with a part of the metal wire 1 embedded therein. The sintering is preferably performed under reduced pressure. The sintered body is subjected to a chemical conversion treatment, to form a dielectric layer 5 on the surface of the sintered body.

The cathode leading layer includes, for example, a carbon layer 8 covering at least part of the solid electrolyte layer 7, and a conductive paste layer 9 covering the carbon layer 8. The conductive paste layer 9 can be, for example, a silver paste layer containing silver particles as metal particles. The carbon layer 8 is constituted of a composition containing a conductive carbon material, such as graphite.

The cathode foil 20 is connected to the cathode leading layer via an adhesive layer 30 having conductivity. The adhesive layer may be, for example, a conductive adhesive. The adhesive layer contains, for example, silver. The adhesive layer may be a silver paste layer similar to the conductive paste layer 9. The cathode foil 20 is stacked so as to overlap the capacitor element 10, forming a stack.

The anode body 3 has a substantially rectangular parallelepiped outer shape, and an electrolytic capacitor 200 also has a substantially rectangular parallelepiped outer shape. The package body 14 has a first principal surface 14a and a second principal surface 14b opposite the first principal surface 14a. The end face 1a of the protruding end of the metal wire of the capacitor element 10 is exposed on the first principal surface 14a. The end face 1a exposed from the package body 14 is electrically connected to a first external electrode 21 extending along the first principal surface 14a. On the second principal surface 14b, an end face 20a of the cathode foil 20 is exposed from the package body 14. The end face 20a of the cathode foil 20 exposed from the package body 14 is electrically connected to a second external electrode 22 extending along the second principal surface 14b. In this case, the length of the metal wire in the anode part can be shortened, and high capacitance can be achieved. In addition, the contribution of the ESR and ESL due to the metal wire is reduced.

The end face 1a of the tip end of the metal wire exposed from the package body 14 and the end face 20a of the cathode foil 20 exposed from the package body 14 are covered with the first external electrode 21 and the second external electrode 22, respectively. The first external electrode 21 and the second external electrode 22 have the same configurations as those of the first external electrode 21 and the second external electrode 22 of the electrolytic capacitor 100 illustrated in FIG. 1.

In the electrolytic capacitor illustrated in FIG. 4, the thickness T1 of the package body located above the stack in the stacking direction of the capacitor element 10 and the cathode foil 20 is 24.9% or more of the thickness T2 of the stack in the stacking direction (T1/T2>0.249). By setting as above, even when the electrolytic capacitor is exposed to high temperatures during reflow or the like, the cathode foil 20 and the cathode leading layer 9 are unlikely to be disbonded from each other due to the swelling deformation of the package body, so that the increase of ESR is suppressed, and low ESR can be maintained.

### Fourth Embodiment

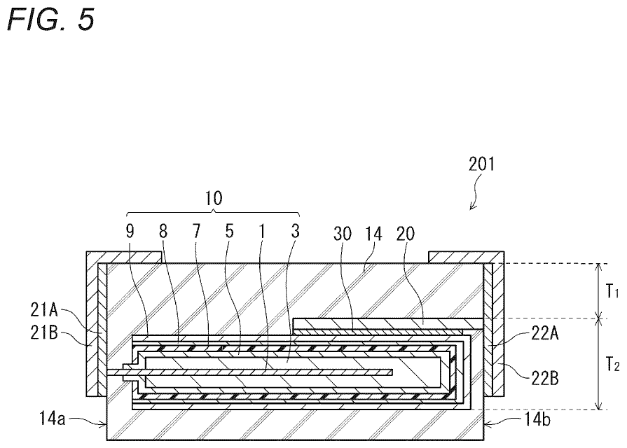

FIG. 5 is a schematic sectional view of an electrolytic capacitor according to yet another embodiment of the present disclosure. An electrolytic capacitor 201 according to the present embodiment is configured similarly to the electrolytic capacitor 200 of the third embodiment, except the configurations of the first external electrode 21 and the second external electrode 22.

The first external electrode 21 and the second external electrode 22 of the electrolytic capacitor 201 have silver paste layers (conductive layers) 21A and 22A, respectively, covering the first principal surface 14a and the second principal surface 14b of the package body 14. The silver paste layer 21A covers the first principal surface 14a of the package body 14 and the end face 1a of the protruding end of the metal wire. The silver paste layer 22A covers the second principal surface 14b of the package body 14 and the end face 20a of the cathode foil 20. The first external electrode 21 and the second external electrode 22 respectively have a first lead frame 21B covering at least part of the silver paste layer 21A and a second lead frame 22B covering at least part of the silver paste layer 22A.

In the electrolytic capacitor illustrated in FIG. 5, the thickness T1 of the package body located above the stack in the stacking direction of the capacitor element 10 and the cathode foil 20, is 24.9% or more of the thickness T2 of the stack in the stacking direction (T1/T2>0.249). By setting as above, even when the electrolytic capacitor is exposed to high temperatures during reflow or the like, the cathode foil 20 and the cathode leading layer 9 are unlikely to be disbonded from each other due to the swelling deformation of the package body, so that the increase of ESR is suppressed, and low ESR can be maintained.

### Fifth Embodiment

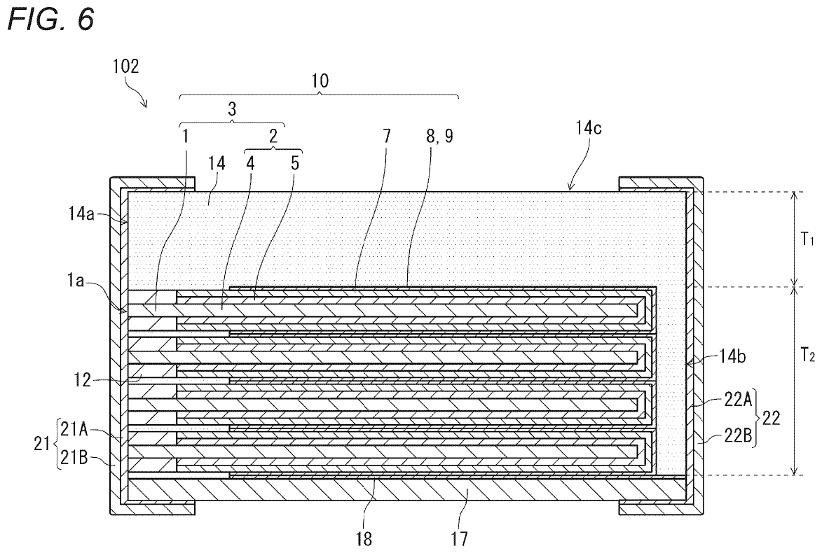

FIG. 6 is a schematic sectional view of an electrolytic capacitor according to yet another embodiment of the present disclosure. An electrolytic capacitor 102 according to the present embodiment is configured similarly to the electrolytic capacitor 100 of the first embodiment, except for not including the cathode foils 20. A plurality of capacitor elements are stacked together, such that their cathode leading layers (conductive paste layers 9) are overlapped with each other, constituting a stack. The stacking direction of the stack is perpendicular to the principal surface of the anode foil.

In the electrolytic capacitor illustrated in FIG. 6, the thickness T1 of the package body located above the stack in the stacking direction is 24.9% or more of the total thickness T2 of the stack in the stacking direction (T1/T2>0.249). By setting as above, even when the electrolytic capacitor is exposed to high temperatures during reflow or the like, it is unlikely to occur that the adhesiveness between the first portion 1 of the anode body 3 and the package body 14 is reduced due to the swelling deformation of the package body, and air, water, and the like enter through the gap between the first portion 1 and the outer package 14. As a result, even after high-temperature treatment, the increase of ESR is suppressed, and low ESR can be maintained.

The capacitor elements and the stack can be electrically connected to the wiring pattern on the substrate 17 via the conductive adhesive layer 18. The conductive adhesive layer 18 may be extended toward the second external electrode 22. The end face of the conductive adhesive layer 18 may be exposed from the package body on the second principal surface 14b of the package body, and electrically connected to the second external electrode 22.

### <<Supplementary Notes>>

The above description of embodiments discloses the following techniques.

### (Technique 1)

An electrolytic capacitor, comprising:
a capacitor element having an anode part and a cathode part;
a cathode foil electrically connected to the cathode part; and
a package body sealing the capacitor element, wherein
the capacitor element and the cathode foil are stacked together, constituting a stack in which the cathode part of the capacitor element is electrically connected to the cathode foil,
the package body contains an epoxy resin, and
a thickness of the package body located above or below the stack in a stacking direction of the stack is 24.9% or more of a thickness of the stack in the stacking direction.

### (Technique 2)

The electrolytic capacitor according to technique 1, wherein a part of the cathode foil is exposed from the package body, and the exposed portion is electrically connected to an external electrode.

### (Technique 3)

An electrolytic capacitor comprising:
a capacitor element having an anode part in a foil form, and a cathode part; and
a package body sealing the capacitor element, wherein
an end face of the anode part is exposed from the package body, and the exposed portion is electrically connected to an external electrode,
the package body contains an epoxy resin, and
a thickness of the package body located above or below the capacitor element in a perpendicular direction to a principal surface of the anode part is 24.9% or more of a total thickness of the capacitor element in the perpendicular direction.

### (Technique 4)

The electrolytic capacitor according to any one of techniques 1 to 3, wherein
the package body contains a filler having an average particle diameter of 12 μm to 32 μm, and
a ratio of the filler in the package body is 73 mass % or more and 84 mass % or less.

### (Technique 5)

The electrolytic capacitor according to any one of techniques 1 to 4, wherein
the package body contains a filler, and
in a particle diameter distribution of the filler, the filler having a particle diameter ranging from 12 μm to 32 μm accounts for 30% to 90% by volume of a total.

### (Technique 6)

The electrolytic capacitor according to any one of techniques 1 to 5, wherein the epoxy resin includes a biphenylaralkyl-type epoxy resin.

### (Technique 7)

The electrolytic capacitor according to any one of techniques 1 to 6, wherein a linear expansion coefficient α1 of the package body is 13×10⁻⁶/° C. or more and 21×10⁻⁶/° C. or less, and a linear expansion coefficient α2 of the package body is 52×10⁻⁶/° C. or more and 74×10⁻⁶/° C. or less.

### (Technique 8)

The electrolytic capacitor according to any one of techniques 1 to 7, wherein a moisture absorption percentage of the epoxy resin at 85° C. and 85% relative humidity is 0.23% or more and 0.34% or less.

### EXAMPLES

The electrolytic capacitor according to the present disclosure will be specifically described below with reference to Examples and Comparative Examples. The present disclosure, however, is not limited to the following Examples.

### Example 1

### (1) Fabrication of Electrolytic Capacitor

A plurality of capacitor elements were prepared to fabricate an electrolytic capacitor similar to an electrolytic capacitor 100 as illustrated in FIG. 1. For the anode body, an anode foil made of aluminum with a porous portion formed thereon by etching was used. Seven capacitor elements were stacked together, with a cathode foil of an aluminum foil having a carbon coating interposed therebetween, to obtain a stack. The cathode foil was disposed such that a portion thereof protrudes from the cathode layer toward the side opposite to the anode body.

A substrate with the stack mounted thereon was placed in a predetermined position in a mold, and after an epoxy resin composition was poured into the mold, the resin was cured, followed by compression molding, so that the stack was sealed entirely with a package body. The epoxy resin composition used here was one containing a filler and an epoxy resin, in which the blended ratio of the filler to the total solids was 73 mass %. The epoxy resin used here was a polyaromatic biphenylaralkyl-type epoxy resin (G720TD Ver.GR manufactured by Sumitomo Bakelite Co., Ltd.). The linear expansion coefficient α1 and the linear expansion coefficient α2 of the package body measured by the aforementioned method were 21×10⁻⁶/° C. and 74×10⁻⁶/° C., respectively, and the moisture absorption percentage of the epoxy resin measured by the aforementioned method was 0.34%.

The thickness T2 of the stack in the stacking direction was 1.482 mm. In the package body, the thickness T1 of the package body above the stack was 0.369 mm. The ratio of the thickness T1 to the thickness T2 was 24.9% (T1/T2=0.249).

Next, portions on the first end side of the first portions were removed together with the package body by shaving, to expose the end faces of the anode bodies. Likewise, the protruding portions of the cathode foils were removed together with the package body by shaving, to expose the end faces of the cathode foils.

Subsequently, the end faces of the anode bodies and the exposed surfaces of the package body where the anode bodies were exposed were covered with silver paste, and the end faces of the cathode foils and the exposed surfaces of the package body where the cathode foils were exposed were covered with silver paste, followed by drying, to form conductive layers (silver paste layers) each having a thickness of 20 μm. Then, a Ni plating layer (thickness 5 μm) and a Sn plating layer (thickness 5 μm) were sequentially formed on the surfaces of the conductive layers by barrel plating, to form a first external electrode and a second external electrode, respectively. Thus, an electrolytic capacitor A1 was obtained.

### (2) Evaluation

The fabricated electrolytic capacitor was evaluated as follows.

The electrolytic capacitor was connected to an impedance measuring device, and an AC voltage was applied thereto. The initial ESR at 100 kHz and the initial capacitance C₀ at 100 kHz were measured.

The electrolytic capacitor was left to stand in an environment at 155° C. for 24 hours. Then, the electrolytic capacitor was further left to stand in an environment at 85° C. and 85% relative humidity for 12 hours. Thereafter, the electrolytic capacitor was heated to a maximum temperature of 260° C. with simulating reflow, for 30 seconds at most.

The electrolytic capacitor after the heat treatment was connected to the impedance measuring device again, and the ESR and the capacitance were measured in the same manner. With the initial ESR denoted by R₀, and the ESR after the heat treatment denoted by R₁, ΔESR=R₁−R₀ was evaluated as an ESR increase rate. With the initial capacitance denoted by C₀, the capacitance after the heat treatment denoted by C₁, ΔCap=C₀−C₁ was evaluated as a capacitance loss.

In addition, the electrolytic capacitor after the heat treatment was checked for swelling of the package body. On the surface of the package body located above the stack (top surface 14c in FIG. 1), the difference ΔZ=Z₁−Z₀ between a height Z₁ in the stacking direction at the point where the displacement in the stacking direction was largest and a height Z₀ of the top surface 14c before the heat treatment was evaluated as a swelling amount. When ΔZ was a positive value, this means that the package body is deformed so as to swell upward, in the stacking direction.

### Examples 2 and 3

Two electrolytic capacitors having a similar configuration to Example 1 were fabricated, and evaluated in the same manner.

### Examples 4 to 7, Comparative Examples 1 and 2

The ratio T1/T2 of the thickness T1 of the package body to the thickness T2 of the stack in the stacking direction in Example 1 was changed. Electrolytic capacitors were fabricated in the same manner as in Example 1 except the above, and evaluated in the same manner as in Example 1.

In Examples 2 and 3, as in Example 1, the thickness T2 of the stack in the stacking direction was set to 1.482 mm, and the thickness T1 of the package body above the stack was set to 0.369 mm. The ratio of the thickness T1 to T2 was 24.9% (T1/T2=0.249).

In Example 4, the thickness T2 of the stack in the stacking direction was set to 1.482 mm, and the thickness T1 of the package body above the stack was changed to 0.370 mm. The ratio of the thickness T1 to T2 was 24.97% (T1/T2=0.2497).

In Example 5, the thickness T2 of the stack in the stacking direction was set to 1.482 mm, and the thickness T1 of the package body above the stack was changed to 0.371 mm. The ratio of the thickness T1 to T2 was 25.04% (T1/T2=0.2504).

In Examples 6 and 7, the thickness T2 of the stack in the stacking direction was set to 1.482 mm, and the thickness Ti of the package body above the stack was changed to 0.372 mm. The ratio of the thickness T1 to T2 was 25.1% (T1/T2=0.251).

The evaluation results are shown in Table 1. In Table 1, the electrolytic capacitors A1 to A7 correspond to Examples 1 to 7, and electrolytic capacitors B1 and B2 correspond to Comparative Examples 1 and 2. Table 2 shows that electrolytic capacitors A1 to A7 in which the thickness ratio T1/T2 was 0.249 (24.9%) or more, the ΔZ was small, indicating that the swelling of the package body was suppressed. When the thickness ratio T1/T2 was 0.249 (24.9%) or more, the ΔESR was significantly reduced as compared to in the electrolytic capacitors B1 and B2 in which the thickness ratio T1/T2 was less than 0.249 (24.9%), indicating that the increase of ESR after high-temperature treatment was significantly suppressed.

TABLE 1

| | ratio of | swelling | | |
|---|---|---|---|---|
| | thickness of | amount | | |
| electrolytic | package body | ΔZ | ΔESR | ΔCap |
| capacitor | T1/T2 | (mm) | (mΩ) | (μF) |
| B1 | 0.248 | 0.005 | 0.865 | 16.5 |
| B2 | 0.248 | 0.012 | 0.792 | 43.8 |
| A1 | 0.249 | −0.001 | −0.008 | 5.21 |
| A2 | 0.249 | −0.001 | −0.008 | 6.21 |
| A3 | 0.249 | −0.001 | −0.022 | 2.54 |
| A4 | 0.2497 | −0.002 | −0.151 | 1.25 |
| A5 | 0.2504 | 0.000 | −0.133 | 0.797 |
| A6 | 0.251 | 0.000 | −0.207 | 1.15 |
| A7 | 0.251 | −0.001 | −0.111 | 2.00 |

The electrolytic capacitor according to the present invention can maintain low ESR even in high-temperature environments, and therefore, can be used for a variety of applications.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

### REFERENCE NUMERALS

1 first portion (anode leading portion), metal wire
   1a end face of first end
2 second portion (cathode forming portion)
   2a end face of second end
3 anode body
4 metal core portion
5 porous portion
6 cathode part
7 solid electrolyte layer
8 carbon layer
9 silver paste layer
10 capacitor element
   10a first capacitor element
   10b second capacitor element
12 separation layer (insulating member)
14 package body
   14a first principal surface of package body
   14b second principal surface of package body
   14c top surface of the package body
17 substrate
18 resin adhesive layer
20 cathode foil
   20a end face of cathode foil
21 first external electrode (external anode electrode)
   21A silver paste layer
   21B Ni/Sn plating layer, first lead frame
22 second external electrode (external cathode electrode)
   22A silver paste layer
   22B Ni/Sn plating layer, second lead frame
100 to 102, 200, 201 electrolytic capacitor

What is claimed is:

1. An electrolytic capacitor, comprising:
a capacitor element having an anode part and a cathode part;
a cathode foil electrically connected to the cathode part; and
a package body sealing the capacitor element, wherein
the capacitor element and the cathode foil are stacked together, constituting a stack in which the cathode part of the capacitor element is electrically connected to the cathode foil,
the package body contains an epoxy resin, and
a thickness of the package body located above or below the stack in a stacking direction of the stack is 24.9% or more of a thickness of the stack in the stacking direction.

2. The electrolytic capacitor according to claim 1, wherein a part of the cathode foil is exposed from the package body, and the exposed portion is electrically connected to an external electrode.

3. An electrolytic capacitor comprising:
a capacitor element having an anode part in a foil form, and a cathode part; and
a package body sealing the capacitor element, wherein
an end face of the anode part is exposed from the package body, and the exposed portion is electrically connected to an external electrode,
the package body contains an epoxy resin, and
a thickness of the package body located above or below the capacitor element in a perpendicular direction to a principal surface of the anode part is 24.9% or more of a total thickness of the capacitor element in the perpendicular direction.

4. The electrolytic capacitor according to claim 1, wherein
the package body contains a filler having an average particle diameter of 12 μm to 32 μm, and
a ratio of the filler in the package body is 73 mass % or more and 84 mass % or less.

5. The electrolytic capacitor according to claim 1, wherein
the package body contains a filler, and
in a particle diameter distribution of the filler, the filler having a particle diameter ranging from 12 μm to 32 μm accounts for 30% to 90% by volume of a total.

6. The electrolytic capacitor according to claim 1, wherein the epoxy resin includes a biphenylaralkyl-type epoxy resin.

7. The electrolytic capacitor according to claim 1, wherein
a linear expansion coefficient α1 of the package body is 13×10⁻⁶/° C. or more and 21×10⁻⁶/° C. or less, and
a linear expansion coefficient α2 of the package body is 52×10⁻⁶/° C. or more and 74×10⁻⁶/° C. or less.

8. The electrolytic capacitor according to claim 1, wherein a moisture absorption percentage of the epoxy resin at 85° C. and 85% relative humidity is 0.23% or more and 0.34% or less.
